(19) United States
(12) Patent Application Publication
(10) Pub. No.: US 2010/0167258 A1
(43) Pub. Date: Jul. 1, 2010

(54) BOOK WITH LIGHT DEVICES AND RELATED PAGE IDENTIFIER

(75) Inventors: Graziano Giovanni RAVIZZA, Cinisello Balsamo (MI) (IT); Roberto GATTI, San Donato Milanese (MI) (IT)

Correspondence Address: YOUNG & THOMPSON, 209 Madison Street, Suite 500, Alexandria, VA, 22314, US

(73) Assignee: ROBOTOONS SRL, MILANO (IT)

(21) Appl. No.: 12/345,915

(22) Filed: Dec. 30, 2008

(51) Int. Cl. G09B 5/00; B42D 3/12

(52) U.S. Cl. 434/309; 281/15.1; 281/29; 434/317; 369/30.02

(57) ABSTRACT

A book (100) includes a front cover (A), a back cover (B) and a plurality of intermediate sheets (1-11) disposed between the front cover (A) and the back cover (B) so as to define a plurality of printed pages (P1-P12), the covers (A, B) and the intermediate sheets (1-11) being bound, by means of a binder (20), on the left-hand edge of the book. A printed circuit board (30) with a plurality of LEDs (L1-L8) is disposed in the back cover (B), and slots (S) in the back cover (B) make the LEDs (L1-L8) visible. Through holes (F) are made in at least some of the intermediate sheets (2-11) to make visible the respective LED coinciding with the through hole (F). A magnetic page identifier (40) for identifying the pages that are being read is also disclosed.

The present invention refers to the field of multimedia books or “techno-books” which, besides the printed page, use particular electronic devices integrated into the book to communicate an item of information. The present invention refers in particular to a book with light devices and to a related page identifier.

Techno-books of the prior art, generally for children, provide for the integration of audio playing devices, to play sounds, music and words, possibly associated with the printed pages of the book and/or light devices in the form of a LED that can be lit by means of a button.

Even if small-sized light devices, such as LEDs, are known to the art, providing a techno-book with such light devices has never been thought of, because of the intrinsic difficulty in integrating the various light devices into the book. In fact, if 8 light points per page are desired, for example, a book with 10 pages would need 80 LEDs, which proves to be an excessively high number to be managed in a book. Furthermore, there would be difficulties in creating a printed circuit to support each page, in bringing the power supply to each page, and in creating a centralised controller for each page.

Techno-books with an audio playing device, according to the prior art, sometimes comprise a page identifier device or “page ID”. Various sounds and/or voices associated with the pages of the book are stored in the audio playing device. The page ID identifies the page opened by the user and, accordingly, the audio player device plays the sound or the voice associated with that page.

U.S. Pat. No. 6,729,543 discloses an optical page ID which uses as page distinguishing key a code which is read by an optical sensor, such as a scanner. This scanner proves bulky, costly and difficult to integrate into a book.

U.S. Pat. No. 5,900,943 and EP 1 010 058 disclose optical page IDs which use as page distinguishing key a colour which is measured by a suitable sensor. Very sensitive and therefore very costly sensors are needed to distinguish the page colours well.

U.S. Pat. No. 6,262,662 discloses an electromagnetic (rf) page ID which uses, as page distinguishing key, a RFID tag which is inserted into the page itself. However, it proves difficult to integrate a tag reader into the book. Furthermore, the tag reader is known to emit radio waves continuously. Therefore, this system is not very suitable for a book, so as not to subject the user, generally a child, to a pointless exposure to electromagnetic waves.

U.S. Pat. No. 5,707,240 discloses a magnetic page ID which uses, as page distinguishing key, an array of N sensors placed on the supporting page and a magnet per page (N) placed in different positions, so as to activate a single sensor of the array. In this case the page ID proves excessively costly, because it requires arrays of sensors. Furthermore, use thereof is limited to books with few pages (less than 10 pages) because of the excessive size of the sensor arrays.

Object of the present invention is to overcome the drawbacks of the prior art, by providing a book with light devices and a related page identifier that are efficient, occupy little space, and are cheap and simple to produce.

This object is achieved in accordance the invention with the book and the page identifier whose characteristics are listed in appended independent claims 1 and 17.

Advantageous embodiments of the invention are apparent from the dependent claims. The book according to the invention comprises a front cover, a back cover and a plurality of intermediate sheets disposed between the front cover and the back cover so as to define a plurality of printed pages The covers and the intermediate sheets are bound, by means of a binder, on the left-hand edge of the book.

A printed circuit board on which are mounted a plurality of LEDS in suitable positions is disposed in the back cover. Slots coinciding with the LEDS are made on the upper side of the back cover to make them visible.

In at least some of said intermediate sheets, through holes are made in register with each other and with at least some of the slots in the back cover to make visible the respective LED coinciding with the through hole made in the intermediate sheet.

The advantages of the book according to the invention are obvious in that it uses a limited number of light sources to illuminate a plurality of pages.

The book advantageously also comprises a page identifier comprising:
a linear magnetic sensor, of the Hall-effect type, mounted on the circuit board disposed in the back cover of the book, and
a plurality of magnets mounted in each of the intermediate sheets upon which the page is to be identified.

Further characteristics of the invention will be made clearer by the detailed description that follows, referring to a purely exemplifying and therefore non limiting embodiment thereof, illustrated in the appended drawings, wherein:

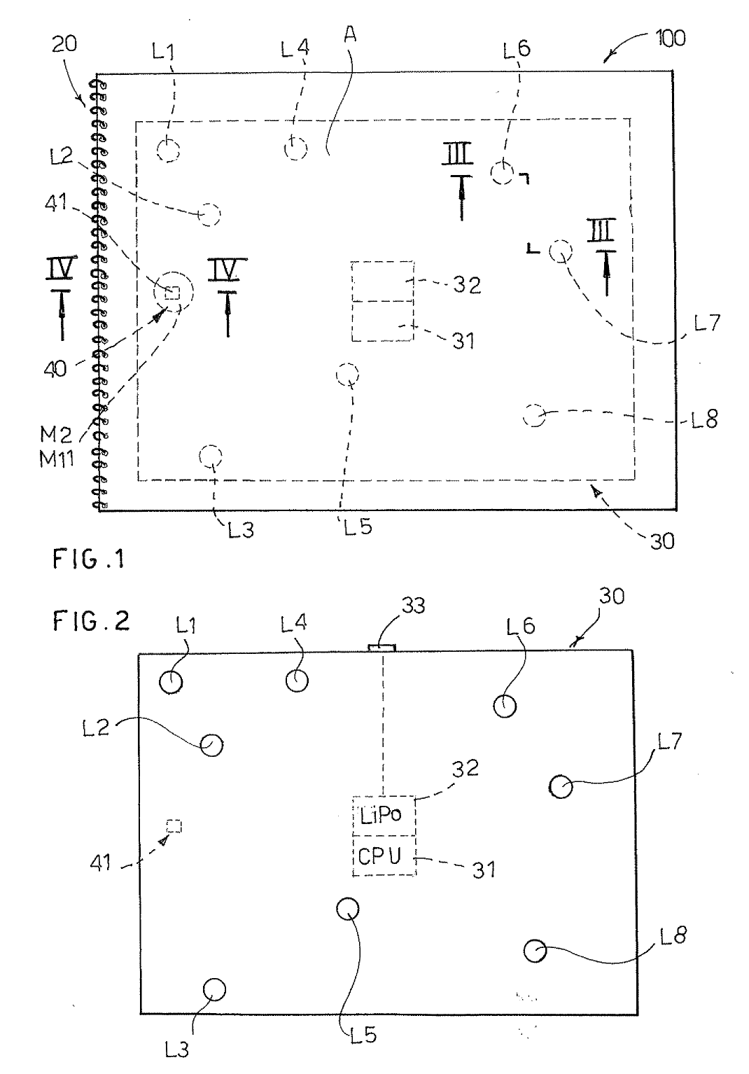

FIG. 1 is a top plan view of the book according to the invention;

FIG. 2 is a top plan view of the printed circuit board used in the book according to the invention;

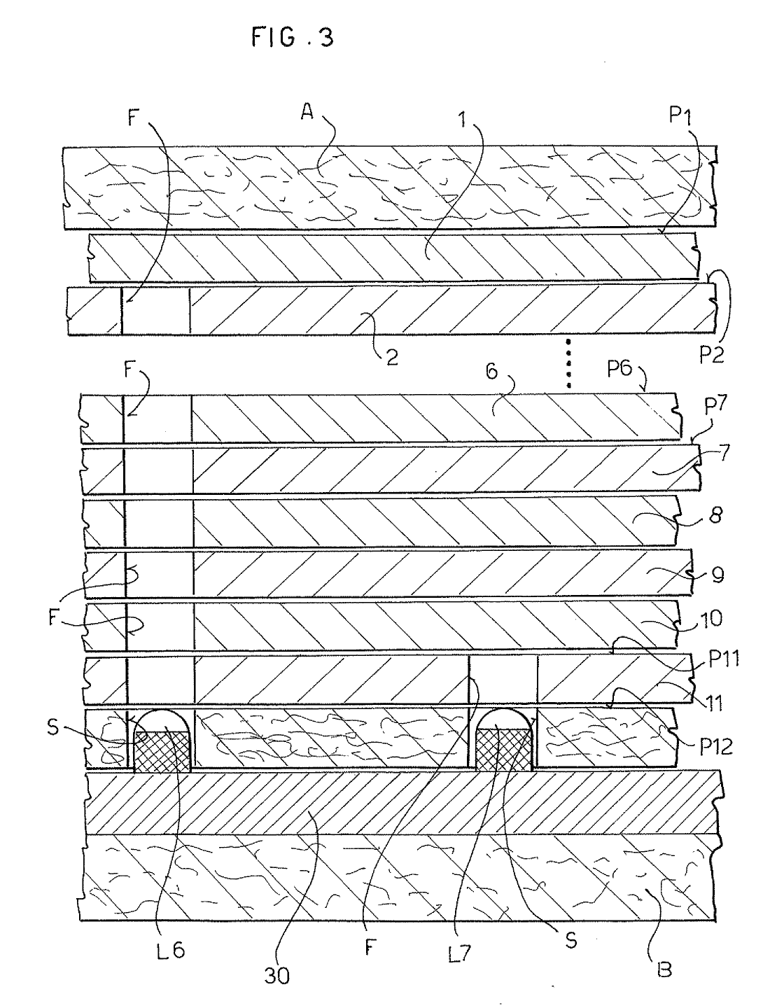

FIG. 3 is a cross sectional view, taken along the plane of section III-III of FIG. 1;

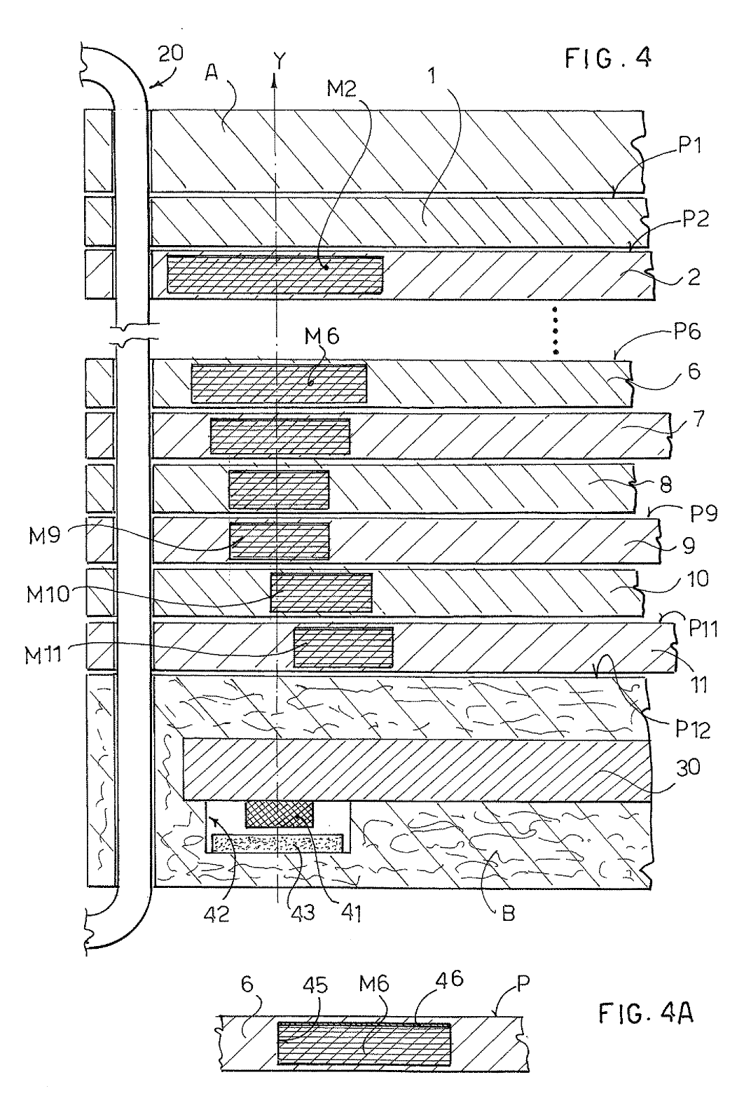

FIG. 4 is a cross sectional view, taken along the plane of section IV-IV of FIG. 1, and

FIG. 4A is a detail of FIG. 4 showing a magnet disposed in a sheet of the book.

The book according to the invention, designated as a whole with reference numeral 100, is described with the aid of the figures.

The book 100 comprises a front cover A, a back cover B and a plurality of intermediate sheets 1-11, interposed between the front cover A and the back cover B. The printable pages of the book are the insides of the covers A and B and the front and back of each intermediate sheet.

If for example, eleven intermediate sheets 1-11 are used, a book with 24 sides and twelve pages P1-P12 is obtained, in which each page comprises two sides. In fact, the first page P1 is formed by the bottom side of the front cover A and the upper side of the first sheet 1, the intermediate pages P2-P11 are formed respectively by the bottom side of an intermediate sheet and the upper side of the next sheet and the last page P12 is formed by the bottom side of the last sheet 11 and the upper side of the back cover B.

The front cover 1, the intermediate sheets 1-11 and the back cover B are bound on their left edge, by means of a per se known binding system 20. The binding system 20 can comprise, for example, a coil which is inserted in suitable holes formed near the side edge of the front cover A, the sheets 1-11 and the back cover B. Clearly other binding systems can be provided, such as adhesive means, click-in means, sewing and the like.

A printed circuit board 30 having a slightly lower surface that that of the cover B is disposed in the back cover B. A plurality of LEDs L1-L8, spread out in suitable positions, are mounted on the printed circuit board 30. For example, eight LEDs L1-L8 are mounted. LEDs L1-L8 are preferably of the of the RGB (Red-Green-Blue) type so as to be able to emit light of any colour from the combination of the three primary colours.

The LEDs L1-L8 are connected, by means of tracks formed on the board 30, to a CPU 31 which controls them, so as to generate LED light animations. The CPU 31 is mounted on the circuit board 30 and is connected to a suitable supply source, such as a LiPo (lithium-polymer) battery 32 suitable for powering the LEDs. Mounted on the circuit board 30 is a USB miniport 33 that protrudes from one edge of the board, coinciding with an aperture of the back cover B to be accessible to a USB cable which can be connected to a PC or to a power supply to supply the LiPo battery 32.

Furthermore the animations of the LEDs L1-L8 can be stored in the flash memory of the CPU. In this case various animations can be downloaded from a PC, through a USB miniport 33. Thus in the case of books for children to be coloured, the user can colour the book and load into the memory of the CPU 31 the appropriate LED animations, which are considered useful to enrich the drawing.

Furthermore, the USB miniport (33) can allow the book to be connected to the web (Internet) using the communication resources of a normal PC.

As shown in FIG. 3, the back cover B has slots S coinciding with each LED L1-L8, so as to make visible all the LEDs L1-L8 in the last page P12 of the book, namely the page printed on the upper side of the cover B.

The intermediate sheets 1-11 have die-cuts F, in the form of through holes, in register with each other and with some of the slots S in the back cover B, so that the respective LED is visible through the hole F and any holes beneath it.

For example, if the LED L6 must be visible on the second page P2 (the page of the second sheet 2), the holes F coincident with the LED L6 must be cut on page 2 and all the underlying pages 3-11, up to the slot S of the LED L6. In this manner, the LED L6 not only is visible on page P2, but it is also visible on all the other underlying pages P3-P12.

On the other hand, if for example the LED L7 must be visible only in the penultimate page P11 (the page of the last sheet 11) it is sufficient to make a single through hole F in the sheet T1, to coincide with the slot S in the LED L7.

In order to obtain a LED light/colour animation coherent with the element or elements to be represented in each page P2-P12, the book according to the invention has a page identifier 40, able to provide the CPU 31 with an indication of the page that the reader is reading, namely the page in the book that is open.

As shown in FIG. 4, the page identifier 40 is of the magnetic type and comprises a Hall-effect linear magnetic field sensor 41, mounted on the circuit board 30, and a magnet M2-M11 disposed in each intermediate sheet 2-11 in which the respective LEDs must be visible. By way of example, the first page P1 of the book does not require illumination, so it can be devoid of holes F and magnets. Thus, ten magnets M2-M11, disposed respectively in the intermediate sheets 2-11, are provided in the book 100.

The sensor 41 is connected to the CPU 31 of the circuit board and is powered by the same LiPo battery 32 that powers the LEDs. The sensor 41 can, for example, be the Honeywell SS94A2 sensor, whose technical specifications can be found in its data sheet.

As shown in FIG. 4A, in each intermediate sheet 2-11, which must accommodate the respective magnet M2-M11, is formed a blind hole 45, open at the top, into which the respective magnet M2-M11 is inserted. The hole 45 is subsequently covered with an adhesive strip 46 suited to the image shown in the page concerned.

The thickness of the magnets M2-M11 is preferably 1 mm or less. In this manner each intermediate sheet 1-11 can be made, for example, of cardboard with a thickness of 1.1 mm.

When the book 100 is closed, the magnets M2-M11 are disposed in a stack, essentially near the vertical axis Y of the sensor 41. The sensor 41 and the stack of magnets M2-M11 is advantageously disposed near the binder 20, that is, near the left-hand edge of the book 100. In this manner, when the pages P2-P12 are turned, that is, when an angular rotation of the sheets 2-11 around the binding 20 is performed, the movement of the magnets M2-M11 with respect to the sensor 41 is small. Consequently, the changes in the values of the electromagnetic field measured by the sensor 41 are minimal, and a more stable set of reading values is obtained.

The sensor 41 can be disposed, for example, at a distance of 20 mm from the left-hand edge of the book. Since the sheets 2-11 which accommodate the magnets are stiff and the magnets are disposed near to the binder, the sheet generates a sufficiently long lever arm and can easily be rotated by the user, overcoming the attraction force of the magnets. Clearly if the magnets were disposed near the right-hand edge of the book, the user would have difficulty in turning the pages because of the attraction power of the magnets. On the other hand, the magnets M2-M11 must attract each other so to make the magnetic field generated thereby as uniform as possible.

In order to avoid saturating the sensor 41, the magnets M11 and M10 of the last two sheets 10 and 11, namely those nearest the sensor 41, can be offset with respect to the axis Y of the sensor 41, that is, slightly shifted to the right with respect to the axis Y. For example, the nearest magnet M11 has an offset of about 1.5 mm and the next magnet M10 has an offset of about 0.9 mm whereas the other magnets M9-M2 are coaxial with the sensor 41. Furthermore, the magnets of the first pages M6-M2 can be of increasing sizes as they move further away from the sensor 41.

The sensor 41 is advantageously disposed on the bottom surface of the circuit board 30, in a special seat 42 formed in the back cover B, so as to be at the greatest possible distance from the nearest magnet M11. In this case the sensor 41 is situated at a distance of over 2 mm from the nearest magnet M11. A ferrite plate 43 which serves to re-focalize the magnetic field detected by the sensor 41 is disposed in the seat 42, beneath the sensor 41.

The back cover B can be made by means of two layers of card which sandwich the circuit board 30. Considering that the total thickness of the circuit board 30 with the components mounted thereon (LEDs L1-L8 on the top surface and sensor 41 on the bottom surface), is less than 5 mm, the back cover B can be made with a total thickness of about 5 mm, so as to cover the circuit board.

Operation of the page identifier 40 is described hereunder. The magnets M2-M11 are disposed and selected in such a way that their magnetic field flow intensity is summed in the sensitive area of the sensor 41, when the magnets M2-M11 are stacked on one another. When a page is opened, a magnet shifts from the vertical axis Y of the sensor 41 and is moved away. In this manner the magnetic field-flow measured by the sensor 41 decreases.

The voltage output of the linear Hall-effect sensor 41 is sampled through an analog-to-digital converter (ADC) integrated into the CPU 31 and the microprocessor inside the CPU 31 distinguishes the page number, using any known distinguishing system. For reasons of linearity of the reading, the intensities of the magnets can be different and the magnets can be made of different materials.

The experimental tests carried out for calibration of the magnetic page identifier are described below.

In a first experimental test, the sensitivity of the sensor 41 was defined at 10 mV/Gauss and the sensor 41 was disposed on the circuit board 30 on the central axis of the book, 20 mm from the left-hand edge of the book.

The page P11 nearest to the sensor 41 was considered as the reference page. A small magnet (disk 1 mm×3 mm dia N30) was then inserted in the sheet 11, such as to obtain a magnetic field reading equivalent to 30 Gauss, by means of the sensor 41. Small magnets M10-M2 with a progressively increasing power were then put in the next pages P10-P2, trying to generate always a field of 30 Gauss/page.

In a first experimental test, the small magnets M11-M2 were all placed on the same axis coinciding with the axis Y of the sensor 41 so as to minimise the non linearity of the magnetic field. In this manner, the fields had to be summed linearly (without distortions), given that the areas having a greater permeability than the air are always situated on the Y axis of the sensor. For this purpose, an attempt was made to put magnets with decreasing power in the pages nearest to the sensor. However, the magnets nearest to the sensor saturated it.

To overcome this drawback, the magnets nearest to the sensor were moved to the right with respect to the axis of the sensor. This prevents saturation of the sensor, but produces two disadvantages:
The non-linearity of the magnetic field of the offset magnets increases; and
There is a shift in the lines of flow of the top magnets M2-M9 which prefer to pass through the area of highest permeability (which now is no longer aligned with respect to the axis Y of the sensor).

In order to find a compromise between saturation of the sensor 41 and the increase in the non linearity of the magnetic field of the nearest magnets, the nearest magnets M11 and M10 were moved with an offset between 0.5-2 mm; to be precise M11 is offset by about 1.5 mm and M10 is offset by 0.9 mm.

In order to compensate for the shift of the lines of flow of the top magnets M2-M9, a small ferrite 43 (for example the ferrite FerroxCube PLT14) was disposed beneath the sensor 41, situated along the axis of the book, which re-focalises the flow lines of said sensor.

Despite these strategies, identification of the last two pages P10 and P11 was very critical. In fact a third form of non linearity due to the fact that the flow lines begin to close parallel to the sensor 41 (no longer perpendicular) comes into play.

To solve this last drawback, the sensor was placed on the other side of the PCB 30 (as shown in FIG. 4) so as to gain at least 1 mm of distance between the nearest magnet M11 and the sensor 41.

It must be considered that for calibration of the page identifier 40, use was made of magnets M2-M8 with variable magnetisation as the distance from the magnetic sensor 41 increases, when the book is closed.

The variable magnetization was obtained with magnets of different sizes (volumes) and/or with magnets of different material or even by moving the magnets with respect to the axis of the magnetic sensor.

The magnetic page identifier 40 according to the invention has advantages with respect to the magnetic page identifiers of the prior art.
A lower cost, since only one magnetic field sensor and a number N of magnets equal to the number of pages to be identified are used, instead of N sensors and N magnets.
Scalability: By suitably calibrating the stack of magnets, the number of pages identified can be increased indefinitely. The limits are due only to the sensitivity of the magnetic sensor used, to the resolution of the ADC used, and to the ability to suitably calibrate the fields generated by the magnets. In magnetic identifiers of the prior art, once the number of magnetic field sensors present in the array has been set at N, only N pages can be distinguished. Furthermore, since the magnets must be spaced apart to avoid interfering with the adjacent sensors, the size of the book would have to be increased considerably in order to increase the number of pages.

Even if the page identifier 40 according to the invention has been described in the specific application of a book with LEDs, it is obvious that it can be applied to any type of book, for example a book provided with an audio playing device that emits an audio signal related to the respective pages that are being read or a book which is connected to a PC by means of the USB miniport (33) can use the communication resources thereof to select the web pages related to the respective paper pages that are being read.

Numerous changes and modifications of detail within the reach of a person skilled in the art can be made to the present embodiment of the invention without thereby departing from the scope of the invention as set forth in the appended claims.

1. A book (100), comprising a front cover (A), a back cover (B) and a plurality of intermediate sheets (1-11) disposed between the front cover (A) and the back cover (B) so as to define a plurality of printed pages (P1-P12), the covers (A, B) and said intermediate sheets (1-11) being bound, by means of a binder (20), on the left-hand edge of the book.
characterised in that it comprises:
a printed circuit board (30) disposed in said back cover (B),
a plurality of LEDs (L1-L8) mounted in suitable positions on said printed circuit board (30),
slots (S) formed in the upper side of said back cover (B) to make said LEDs (L1-L8) visible,
through holes (F) made in at least some of said intermediate sheets (2-11), in register with each other and with at least some of the slots (S) in the back cover (B), to make visible the respective LED coinciding with the through hole (F) made in the intermediate sheet (2-11).

2. A book according to claim 1,
characterised in that said LEDs (L1-L8) are of the RGB type, able to generate light signals of different colours and light animations.

3. A book according to claim 2, characterised in that a CPU (31) able to control the LEDs so as to generate the desired colours and animations is mounted on said printed circuit board (30).

4. A book according to claim 3, characterised in that a USB miniport (33) connected to said CPU (31) is mounted on said printed circuit (30) to download the animation sequence of the LEDs from a PC to the flash memory of the CPU.

5. A book according to claim 4, characterised in that a LiPo type battery (32), adapted to supply the LEDs and chargeable through the USB miniport (33), is mounted on said printed circuit board (30).

6. A book according to claim 1, characterised in that it further comprises a page identifier (40) adapted to identify the page (P1-P12) that is being read, that is, which has been opened, to control the LEDs (L1-L8), and emit sounds according to the page that has been opened.

7. A book according to claim 1, characterised in that it further comprises a page identifier (40) adapted to identify the page (P1-P12) that is being read, that is, which has been opened, to select web (Internet) pages, according to the page that has been opened.

8. A book according to claim 6, characterised in that said page identifier (40) is of the magnetic type.

9. A book according to claim 8, characterised in that said page identifier (40) comprises a Hall-effect linear magnetic sensor (41) mounted on said circuit board (30) and a plurality of magnets (M2-M11) mounted on each of the intermediate sheets (2-11) on which a page (P2-P12) is to be identified.

10. A book according to claim 9, characterised in that the magnetisation of said magnets (M2-M11) varies as their distance from said magnetic sensor (41) increases, when the book is closed.

11. A book according to claim 10, characterised in that the variable magnetisation of the magnets (M2-M11) is obtained by using magnets of different sizes (volumes).

12. A book according to claim 10, characterised in that the variable magnetisation of the magnets (M2-M11) is obtained by using magnets of different materials.

13. A book according to claim 9, characterised in that, when the book is closed, said magnets (M2-M11) are disposed stacked essentially close to the vertical axis (Y) of said magnetic sensor (41).

14. A book according to claim 13, characterised in that said magnetic sensor (41) is disposed near the left-hand edge of said book.

15. A book according to claim 13, characterised in that at least the two magnets (M10, M11) nearest to the sensor (41) are disposed offset with respect to the axis (Y) of the sensor, whereas the other magnets (M2-M9) are coaxial to the sensor.

16. A book according to claim 9, characterised in that said magnetic sensor (41) is disposed on the underside of said circuit board (30), namely the opposite side to that on which the LEDs (L1-L8) are mounted.

17. A page identifier (40) of a book, said book (100) comprising a front cover (A), a back cover (B) and a plurality of intermediate sheets (1-11) disposed between the front cover (A) and the back cover (B) so as to define a plurality of printed pages (P1-P12), said covers (A, B) and said intermediate sheets (1-11) being bound, by means of a binder (20), on the left-hand edge of the book, characterised in that said page identifier (40) comprises:
a Hall-effect linear magnetic sensor (41), mounted on the circuit board (30) disposed in the back cover (B) of the book, and
a plurality of magnets (M2-M11) mounted in each of the intermediate sheets (2-11) upon which the page (P2-P12) is to be identified.

18. A page identifier (40) according to claim 17, characterised in that said magnets (M2-M11) have a variable magnetisation as their distance from said magnetic sensor (41) increases, when the book is closed.

19. A page identifier (40) according to claim 18, characterised in that the variable magnetisation of the magnets (M2-M11) is obtained by using magnets of different sizes (volumes).

20. A page identifier (40) according to claim 18, characterised in that the variable magnetisation of the magnets (M2-M11) is obtained by using magnets of different materials.

21. A page identifier according to claim 17, characterised in that, when the book is closed, said magnets (M2-M11) are disposed stacked essentially close to the vertical axis (Y) of said magnetic sensor (41).

22. A page identifier (40) according to claim 21, characterised in that said magnetic sensor (41) is disposed near the left-hand edge of said book.

23. A page identifier (40) according to claim 21, characterised in that at least the two magnets (M10, M11) nearest to the sensor (41) are disposed offset with respect to the axis (Y) of the sensor, whereas the other magnets (M2-M9) are coaxial to the sensor.

24. A page identifier (40) according to claim 17, characterised in that said magnetic sensor (41) is disposed on the underside of said circuit board (30), namely the opposite side to that on which the LEDs (L1-L8) are mounted.
